(19) United States
(12) Patent Application Publication
(10) Pub. No.: US 2013/0082842 A1
(43) Pub. Date: Apr. 4, 2013

(54) METHOD AND DEVICE FOR FALL DETECTION AND A SYSTEM COMPRISING SUCH DEVICE

(71) Applicant: GENERAL ELECTRIC COMPANY, Schenectady, NY (US)

(72) Inventors: Jeno BALAZS, Budaors (HU); Akos ERDOS, Budaors (HU)

(73) Assignee: GENERAL ELECTRIC COMPANY, Schenectady, NY (US)

(21) Appl. No.: 13/630,828

(22) Filed: Sep. 28, 2012

(30) Foreign Application Priority Data
Sep. 30, 2011 (EP) 11462018.0

(51) Int. Cl. G08B 21/02

(52) U.S. Cl. 340/573.1

(57) ABSTRACT

A device for detecting a fall is provided. The device comprises a horizontal dual element PIR sensor having a vertical axis of symmetry and at least one vertical dual element PIR sensor having a horizontal axis of symmetry. The device further comprises a Fresnel lens arranged in front of the horizontal dual element PIR sensor, and a Fresnel lens arranged in front of the at least one vertical dual element PIR sensor. The device further comprises a signal processing MCU configured to receive output signals from the horizontal dual element PIR sensor and the at least one vertical dual element PIR sensor, to evaluate a phase of the output signals, and to produce a fall detection alert signal in response to a result of the evaluation.

### CROSS-REFERENCE TO RELATED APPLICATIONS

This application claims foreign priority benefits under 35 U.S.C. §119 to co-pending European Patent Application Serial No. 11462018.0, filed Sep. 30, 2011, which is hereby incorporated by reference in its entirety as part of the present disclosure.

### BACKGROUND OF THE INVENTION

The subject matter generally relates to a method and a device for fall detection.

More people rush to U.S. emergency rooms for injuries related to falling than from any other cause. And, according to the American Academy of Family Physicians, they're the primary cause of accidental death in people over the age of 65.

Not surprisingly, as we age, the injuries we sustain from falls become more severe, which is why falls are the cause of 70 percent of accidental deaths in people aged 75 years and older.

The USA Centers for Disease and Prevention provide the following startling facts about falling. One out of three adults age 65 and older falls each year. Among those age 65 and older, falls are the leading cause of death by injury. In addition, they are the most common cause of nonfatal injuries and hospital admissions for trauma. In 2007, over 18,000 older adults died from unintentional fall injuries. Furthermore, the death rates from falls among older men and women have risen sharply over the past decade. In 2009, 2.2 million nonfatal fall injuries among older adults were treated in emergency departments and more than 581,000 of those patients were hospitalized. In 2000, direct medical costs of falls totaled a little over $19 billion including $179 million for fatal falls and $19 billion for nonfatal fall injuries.

Different fall detectors are available. Some detectors measure acceleration and body direction and are attached to a belt of the person. But people refusing or forgetting to wear this kind of detector, still need a way to get help if they are incapable of getting up after a fall. Other sophisticated systems use IR cameras and special image analysis algorithms as described for e.g. in U.S. Pat. No. 7,541,934 entitled “Method and device for fall prevention and detection”. Other methods use special short-range radars. In these cases the main issue is that several elderly people did not want such sophisticated systems installed in their home and environment. Also, these sophisticated systems are not cheap.

As described in the following publication (S. Brownsell and M. Hawley: Automatic fall detectors and the fear of falling. Journal of telemedicine and telecare, 10 (5):262, 2004.) myriads of research has been done to detect falls using wearable sensors, but the problem with these devices is that the elderly people often forget to wear them.

Thus, there is a need for a fall detection apparatus that is cheap and is accepted by elderly users.

The PIR (Passive Infrared) sensors are largely used in burglar detection devices. As such, elderly users are familiar with these devices to protect their property and the devices are largely accepted.

### BRIEF SUMMARY OF THE INVENTION

According to an embodiment of the present invention, a device for detecting a fall is provided. The device comprises a horizontal dual element PIR sensor having a vertical axis of symmetry and at least one vertical dual element PIR sensor having a horizontal axis of symmetry. The device also comprises a Fresnel lens array arranged in front of the horizontal dual element PIR sensor and optically focused in a direction parallel with the axis of symmetry of the horizontal dual element PIR sensor, wherein the Fresnel lens array divides a plane orthogonal to the axis of symmetry of the horizontal dual element PIR sensor into a plurality of horizontal zones, each zone comprising two sectors. The device further comprises a Fresnel lens array arranged in front of the at least one vertical PIR sensor and optically focused in a direction parallel with the axis of symmetry of the at least one vertical dual element PIR sensor, wherein the Fresnel lens array divides a plane orthogonal to the axis of symmetry of the at least one vertical dual element PIR sensor into at least one vertical zone. The device also comprises a signal processing MCU configured to receive output signals from the horizontal dual element PIR sensor and the at least one vertical dual element PIR sensor, to evaluate a phase of the output signals, and to produce a fall detection alert signal in response to a result of the evaluation.

According to another embodiment of the present invention, a method for providing a fall detection signal is provided. The method comprises arranging an infrared Fresnel lens array in front of a horizontal dual element PIR sensor and at least one vertical dual element PIR sensor, the Fresnel lens array having an optical focusing effect in a direction parallel with an axis of symmetry of at least one of the horizontal dual element PIR sensor and the at least one vertical dual element PIR sensor. The method further comprises forwarding output signals of both the horizontal dual element PIR sensor and the at least one vertical dual element PIR sensor to a signal processing MCU, evaluating a phase of the output signals of both the horizontal dual element PIR sensor and the at least one vertical dual element PIR sensor, and producing a fall detection alert signal in response to the result of evaluating the phase of the output signals.

According to another embodiment of the present invention a system comprising at least one device for providing fall detection is provided. The device comprises a horizontal dual element PIR sensor having a vertical axis of symmetry and at least one vertical dual element PIR sensor having a horizontal axis of symmetry. The device also comprises a Fresnel lens array arranged in front of the horizontal dual element PIR sensor and optically focused in a direction parallel with the axis of symmetry of the horizontal dual element PIR sensor, wherein the Fresnel lens array divides a plane orthogonal to the axis of symmetry of the horizontal dual element PIR sensor into a plurality of horizontal zones, each zone comprising two sectors. The device further comprises a Fresnel lens array arranged in front of the at least one vertical PIR sensor and optically focused in a direction parallel with the axis of symmetry of the at least one vertical dual element PIR sensor, wherein the Fresnel lens array divides a plane orthogonal to the axis of symmetry of the at least one vertical dual element PIR sensor into at least one vertical zone. The device also comprises a signal processing MCU configured to receive output signals from the horizontal dual element PIR sensor and the at least one vertical dual element PIR sensor, to evaluate a phase of the output signals, and to produce a fall detection alert signal in response to a result of the evaluation. The system further comprises a control unit comprising a user interface connected to the at least one device through a communication interface, and wherein the control unit is configured to establish real-time communication between a caregiver and a person being supervised.

### BRIEF DESCRIPTION OF THE DRAWINGS

The subject matter will now be described in detail with reference to the accompanying drawings, in which:

FIG. 1 is a top field view of a horizontal movement detector according to an embodiment of the present invention;

FIG. 2 is a side field view of a horizontal movement detector according to an embodiment of the present invention;

FIG. 3 is a top field view of a vertical movement detection Fresnel lens according to an embodiment of the present invention;

FIG. 4 is a side field view of a combination of a vertical movement detection PIR sensor and a Fresnel lens according to an embodiment of the present invention;

FIG. 5 schematically illustrates two PIR sensors in a fall detection unit according to an embodiment of the present invention;

FIG. 6 illustrates signals delivered by both a horizontal and a vertical movement sensing PIR sensor in a fall detection unit according to an embodiment of the present invention;

FIG. 7 is a block diagram of an analog signal processing unit and a digital signal processing MCU in a fall detection unit according to an embodiment of the present invention;

FIG. 8 is a block diagram of a fall detection unit utilizing a mixed signal processing unit according to an embodiment of the present invention;

FIG. 9 depicts a side view of the detection of a standing/lying person by a dual sensor fall detection unit according to an embodiment of the present invention;

FIG. 10 is a block diagram of a triple sensor fall detection unit utilizing a mixed signal processing unit according to an embodiment of the present invention;

FIG. 11 depicts a side view of the detection of a standing/lying person by a triple sensor fall detection unit according to an embodiment of the present invention;

FIG. 12 is a flow-chart of extended sensing algorithms by a triple sensor fall detection unit according to an embodiment of the present invention;

FIG. 13 is a block diagram of a fall detection system according to an embodiment of the present invention; and

FIG. 14 is a flow chart of fall detection by a fall detection unit and a system according to an embodiment of the present invention.

### DETAILED DESCRIPTION OF THE INVENTION

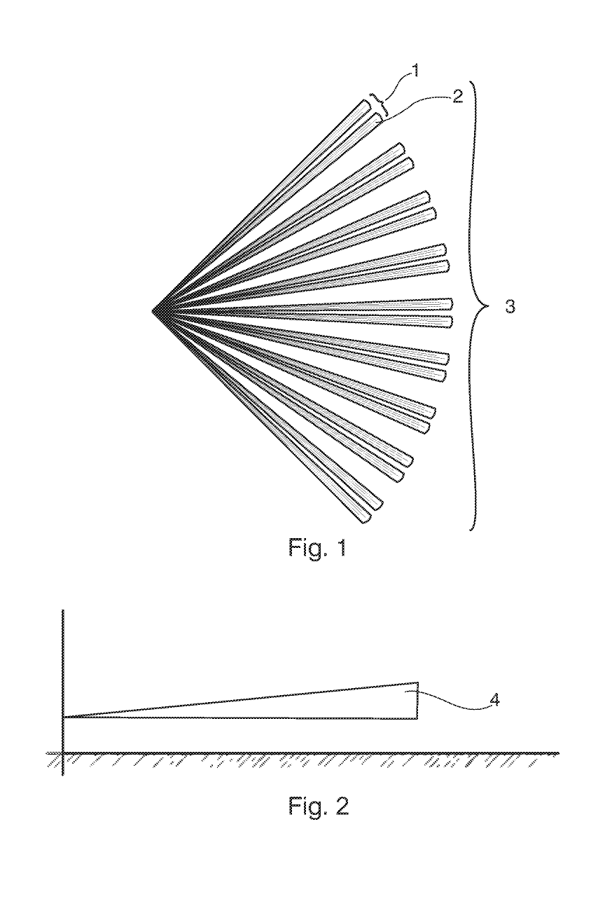

FIG. 1 shows a top field view of an embodiment of a horizontal movement detector comprising a Fresnel lens array. A field of view 3 is divided into a plurality of detection zones 1. Each zone 1 comprises two sectors 2 due to the PIR sensor being a dual type PIR sensor. The angle of the field of view 3 of the horizontal movement detector generally depends on the type of PIR sensor. In general, the angle is between 80° and 110°. Fresnel lenses are used in front of the dual element PIR sensors to detect horizontal movements. A Fresnel lens is arranged in front of the dual element PIR sensors to divide the horizontal plane in several zones 1, for example, nine or more zones 1, within the field of view 3 of a horizontal PIR sensor. Each zone 1 comprises two different sectors 2. Movement of a person across a zone 1, i.e. its sectors 2, situated in said field of view 3 of the horizontal PIR will result in sudden changes in the amount of IR radiation and a signal will be generated at the output of the corresponding PIR sensor. The signal phase directly depends on the horizontal movement direction component of the person, for example left to right or vice versa.

FIG. 2 shows a side view of a horizontal movement detector comprising a Fresnel lens array. The side view includes only one zone 4. In this way the horizontal movement detector is not sensitive to vertical movements.

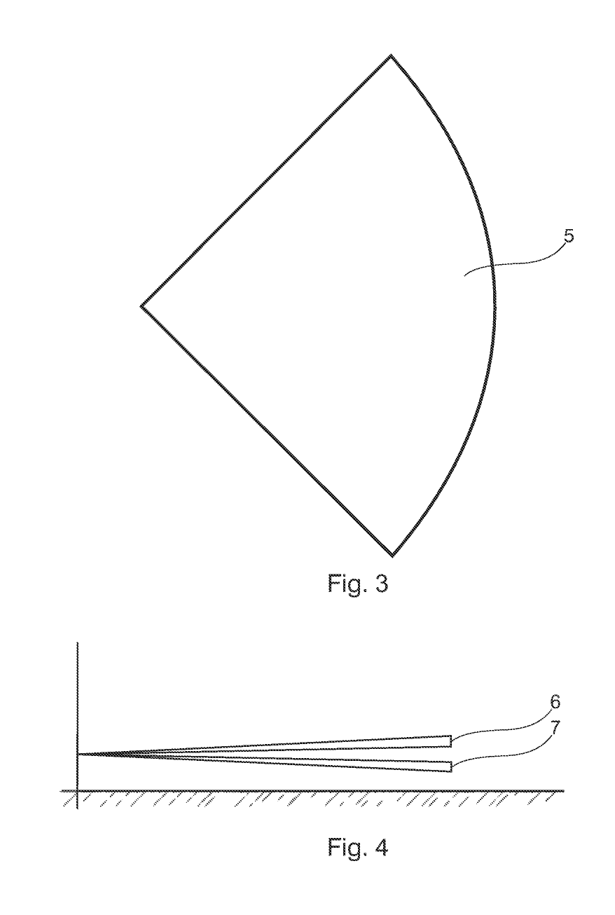

A second PIR sensor is rotated by 90 degrees relative to the horizontal PIR sensor and thus, it has the ability to detect only vertical movements. FIG. 3 shows a top view of the vertical movement detection Fresnel lens. The second PIR sensor and Fresnel lens combination have a single horizontal sector 5. FIG. 4 shows a side view of a vertical movement detection PIR sensor and Fresnel lens combination. Here, two sectors 6 and 7 form one detection zone. The vertical movements are just under the installation plane of the sensor. To fulfill this requirement, a Fresnel lens array, which comprises a horizontal barrier allay with a very sharp field of view, is placed in front of said PIR sensor. The magnitude of this angle depends on the desired maximum distance to survey and the height of the PIR sensor relative to the floor.

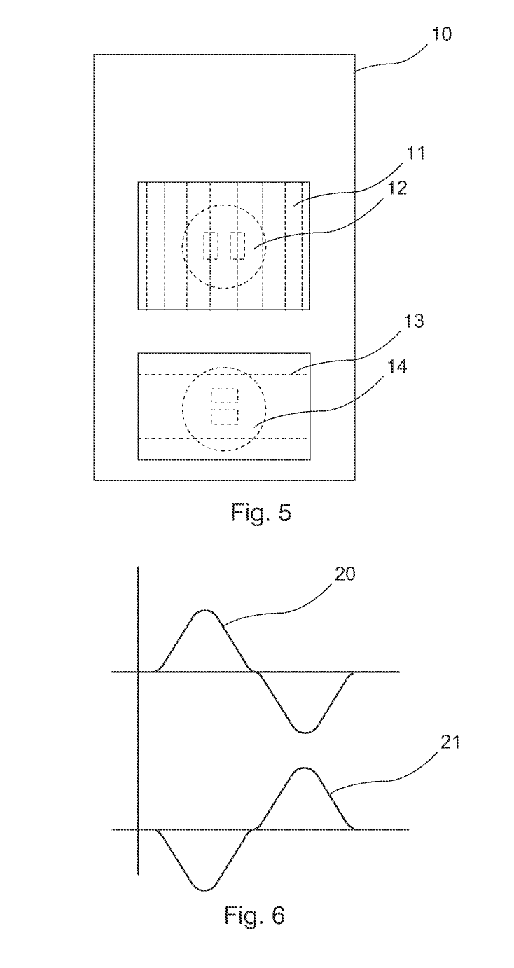

The schematic arrangement of both PIR sensors in the fall detection device is shown in FIG. 5. A PIR detection unit 10 is presented. A horizontal Fresnel lens array 11 and a horizontal PIR sensor 12 are arranged for horizontal movement detection. A vertical Fresnel lens array 13 and a vertical PIR sensor 14 are arranged for vertical movement detection.

According to an embodiment of the present invention, a PIR detection unit 10 comprises a dual element PIR sensor 12, 14 having an axis of symmetry and an infrared lens placed in front of said PIR sensors. The infrared lens divides a plane orthogonal to the axis of symmetry into several zones 1 in the field of view 3 of the PIR detection unit 10. Each zone 1 comprises two different sectors 2. The infrared lens is an array of Fresnel lenses 11, 13 having an optical focusing effect in a direction parallel with the axis of symmetry of the corresponding PIR sensor 12, 14. The two dual element PIR sensors 12, 14 have orthogonal axes of symmetry. The output signals of both PIR sensors 12, 14 are forwarded to a signal processing MCU 35 for evaluating the output signals of the phases of the PIR sensors 12, 14 and producing a fall detection alert signal in response to the result of said evaluation.

According to another embodiment of the present invention, the horizontal PIR sensor 12 has a vertical axis of symmetry and the vertical PIR sensor 14 has a horizontal axis of symmetry.

According to another embodiment of the present invention, the horizontal PIR sensor 12 has zones 4 narrower than 10°. According to another embodiment, the PIR detection unit 10 is mounted on a vertical surface at a position in which the vertical PIR sensor 14 is 0.4-0.9 meters from the floor.

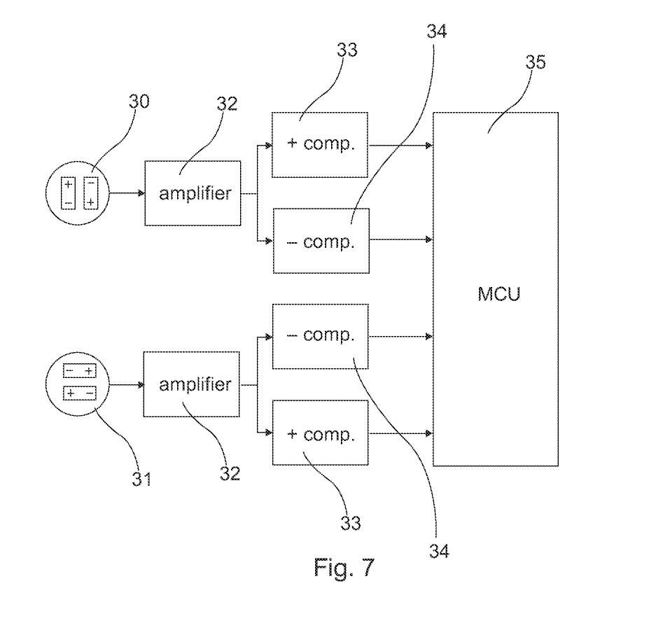

FIG. 6 illustrates the signals delivered by the movement sensing horizontal and vertical PIR sensors 12 and 14. A signal 20 is generated by the PIR sensor detecting right to left or down to up movement. A signal 21 is generated by the PIR sensor detecting left to right or up to down movement. The signals 20, 21 are amplified, according to FIG. 7. In addition, a band pass filter can be utilized to filter out signals in a n undesired frequency range. The phase of the signal is detected by a positive comparator 33 and a negative comparator 34. A similar process is valid for vertical movement detection.

The output signals of amplifiers 32 are fed into comparators 33 and 34 which are connected to the interrupt input of the MCU 35. Instead of the comparators 33 and 34, the signal could be fed into an analog digital converter; however, this would cause the MCU to consume more power and thus, this solution is less practical in a device where low power consumption is necessary.

In the schematic circuit arrangement of FIG. 7, a signal processing MCU 35 receives four signals from four comparators 33, 34. Two of the signals come from the horizontal movement detector of the PIR sensor 30, through an amplifier 32, and are used to detect a horizontal movement. The amplifier 32 may comprise a band pass filter. A movement will be validly detected if a negative signal is followed by, in a predefined time frame, a positive signal, or vice versa. This predefined time frame can be, for example, a value between 1 to 10 seconds. This is important to reduce the eventual noises collected by a PIR sensor 30 or coming from the amplifier 32. In addition, two of the signals come from the vertical movement detector of the PIR sensor 31, through an amplifier 32, and are used to detect a vertical movement. In the same manner as with horizontal movement detection, the movement will be validly detected if a negative signal follows the positive signal in a predetermined time frame, or vice versa. In addition, the direction of the movement is detected for vertical movement as well as horizontal movement.

The role of the band pass filter is to eliminate the DC current component and to filter out noise from the signal. The amplified and filtered signal will be delivered to a positive signal comparator 33 and the negative signal comparator 34. The output of the negative and positive signal comparators are connected to a signal processing unit, the MCU 35.

The MCU 35 may contain an algorithm to process the data received from the PIR sensors 30, 31 and enabled to send an alert message via a communication link. The connection can be wired or wireless depending on the realization of the sensor.

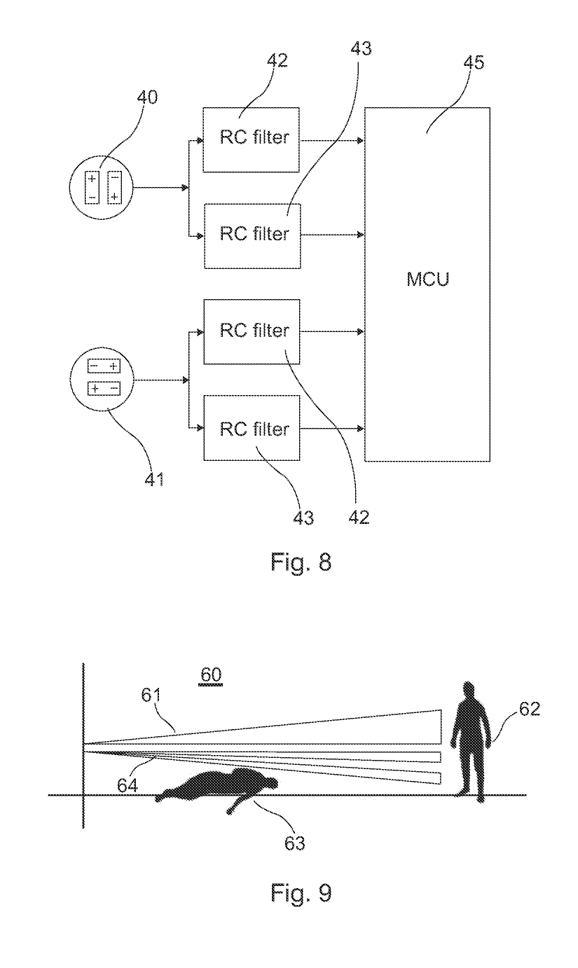

FIG. 8 is a schematic diagram of another circuit for processing the signals from the dual PIR sensors. The PIR sensors are connected to a mixed signal MCU 45 through two RC filters 42 and 43. One of the filters 43 integrates the signal coming from the PIR sensors. The other filter 42 is a low pass filter. The mixed signal digital MCU 45 detects the movements through special algorithms. The raw signal from the PIR detectors 40 and 41 is fed directly to the input of MCU 45. Thus, further signal processing algorithms can be implemented within the MCU 45 for more precise detection of the vertical movements. The raw data coming from the PIR detectors 40 and 41 can be analyzed in a more sophisticated way by the MCU 45.

For reliable sensing, the horizontal sensor should be placed at a height where its field of view comprises each piece of seating in a room and is not covered by higher pieces of furniture.

FIG. 9 illustrates a sensor configuration 60 placed on a wall of a room, wherein the sensors are at about the hip level of a standing person 62. In this configuration, the corresponding sensors have a horizontal zone 61 and a vertical zone 64, including two split sectors. This arrangement will not detect motion when the supervised person has already been lying on the floor. In effect, a lying person 63 will not be identified.

The detection algorithm of the MCU 45 must be able to differentiate several other motion patterns from a fall motion. For example, other motion patterns include, but are not limited to when a person bends down, gets on their knees to pick up an object from the floor or to clean something, climbs down from a ladder, walks down a stairway, sits down on a chair, or lies down on a sofa or bed.

A fall can have different characteristics and thus, differentiating other motions from a fall motion is challenging. A fall can be fast or slow. Moreover, it can start from a standing position or a sitting position or some other posture where the person is initially in a lower position.

In the case of most of the motion patterns described above, there is a high probability that the person is going to move in a horizontal direction after a vertical movement and, a considerable amount of horizontal components of movement may be present during the vertical movement. When a person sits down on a chair, the vertical movement can be presented with a corresponding low frequency and, most likely, is followed by detected horizontal movements as the person moves. Depending on the relative position of the outstanding sensor unit and the chair/sofa, it might be possible that only the head of the person will be visible, and thus detectable, by the sensor. When a person lies down on a sofa or bed, the low frequency vertical motion might not be followed by a horizontal motion if the furniture covers the whole body of the person. This event may be confused with a fall since, in certain cases, a fall might have a relatively low frequency vertical component.

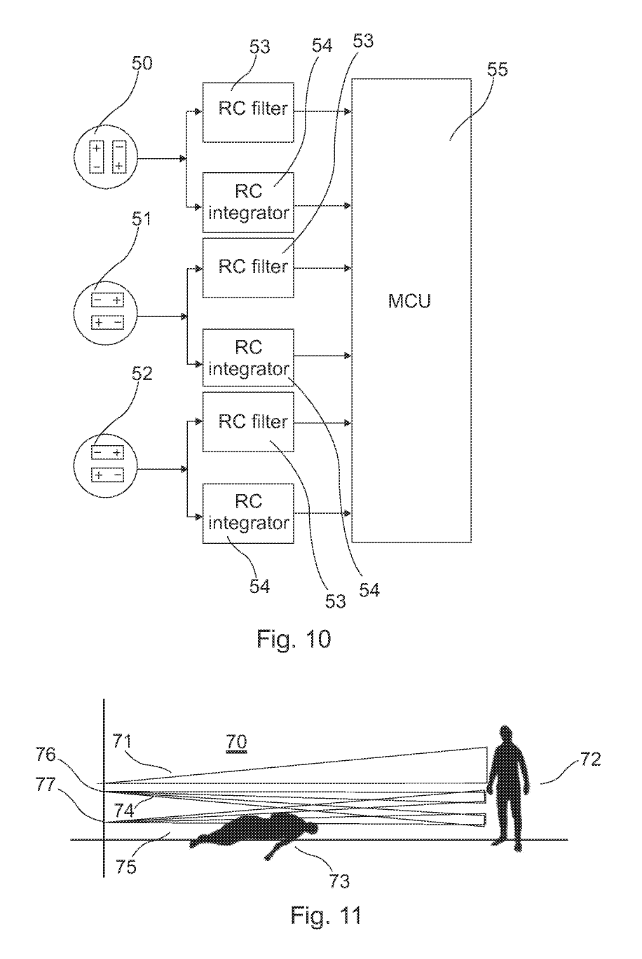

FIG. 10 is a schematic of a circuit capable for capturing a continuous amplitude analog signal indicating the strength of the received signal. FIG. 11 illustrates a fall detecting PIR detection unit 70 wherein the unit uses a signal from a second vertical PIR sensor 77 placed at a convenient vertical distance from the first vertical PIR sensor 76. The unit further comprises a horizontal PIR sensor 50.

A first vertical PIR sensor 76 and a second vertical PIR sensor 77 together provide a sensor configuration 70 as shown in FIG. 11. The processing of signals derived from the first vertical PIR sensor 76 and the second vertical PIR sensor 77 is similar to the case of the embodiment presented in FIG. 8, wherein the raw signals from the PIR sensors 50, 51 and 52 are connected to a low pass RC filter 53 and to an RC integrator 54. The preconditioned signals are fed to the input of the mixed signal processing MCU 55.

The second vertical PIR sensor 77 may be arranged within the PIR detection unit or, in the alternative, as a distinct unit. A sampling rate setting of about 300 Hz and 5-8 bits resolution can obtain reasonably reliable data.

In addition to the basic fall detection capabilities of the PIR sensors 50, 51, 76, 77, the sensors can provide other information useful for monitoring a person in a home environment. The algorithms that differentiate the fall events from other human motion patterns are able to detect motions of normal daily activity like sitting down, lying down, walking, and so on, with a certain probability. This information can be transferred to a monitoring server where it is stored so that further algorithms can utilize the information to determine the health condition of the monitored person, or it can be directly presented to monitoring personnel.

If the motion occurs at a greater distance from the sensor 50, 51, 76 or 77, the frequency of the signal detected by the motion sensor 50, 51, 76 or 77 is lower while the time period of the pattern of fall detection remains the same. Furthermore the infrared signal amplitude decreases with distance from the motion sensor 50, 51, 76 or 77.

The MCU 55 may be configured to compare the time period, amplitude and frequency with one or more predetermined fall event patterns, in order to classify the detected motion and differentiate fall events from non-fall events.

Furthermore, the MCU 55 may be configured to differentiate between different fall patterns in order to determine the seriousness of the fall.

According to another embodiment of the present invention, the device stores patterns from detected sensor data of previous fall events in memory, wherein the fall events have already been confirmed by the user or caregiver. A history of fall event patterns may be learned with appropriate machine learning algorithms, and applied to perform a more reliable classification of further fall events.

Extended sensing algorithms are possible if a device contains a third sensor as shown in FIG. 11. The third sensor is a second vertical PIR sensor 77, in addition to the basic first vertical PIR sensor 76, having a view of the lower field of the area to be monitored. The horizontal zone 71 is the same as horizontal zone 61 in sensor configuration 60 of FIG. 9. In this case, however, the vertical detection is divided into two different zones 74, 75 wherein in the upper zone 74 vertical motion at hip level is detected by the first vertical PIR sensor 76, and in the lower zone 75 motion below about an upright human hip level is detected by the second vertical PIR sensor 77. The different zones 74, 75 may intersect with each other at a certain horizontal distance.

In general, the second vertical PIR sensor 77, placed in a lower position, identifies the time range of detection of a downward direction vertical motion signal after the upper first vertical PIR sensor 76 has stopped detecting motion. If the value of this time range exceeds a certain threshold level, the second vertical PIR sensor 77 indicates that the moving person probably had a fall. With this sensor arrangement, detecting whether the motion of a person reached the ground can be achieved with greater confidence.

A properly arranged second vertical motion detector zone 75 can detect whether the person is still moving after the fall. For this purpose, the upper zone 74 is arranged so that it cannot detect a moving person lying on the floor, but the lower zone 75 must be able to partially detect a lying person 73. Accordingly, FIG. 11 illustrates the detection of a standing person 72 and a lying person 73 by a triple sensor fall detection unit according to an embodiment of the present invention.

The MCU may be configured so that, following a predetermined amount of time after the fall, if the lower second vertical PIR sensor 77 detects motion, but the upper first vertical PIR sensor 76 does not, additional information is added to the generated alert signal indicating the previously described circumstances.

With the triple sensor fall detection unit, wherein two vertical PIR sensors are utilized to detect boundary crossing in a vertical direction, it is possible to partially compensate for the effects of sensing at different distances from the sensor.

According to an embodiment of the present invention, a method for fall detection is provided. The method comprises placing infrared Fresnel lenses 11, 13 in an array in front of the corresponding PIR sensor 12, 14, wherein the Fresnel lenses 11, 13 have an optical focusing effect in a direction parallel with the axis of symmetry of the corresponding PIR sensor 12, 14, applying a PIR detection unit 10, comprising two dual element PIR sensors 12, 14 having orthogonal axes of symmetry, forwarding output signals of both PIR sensors 12, 14 to a subsequent signal processing MCU 35, and evaluating the output signals of the PIR sensors 12, 14 at least in their phases and producing a fall detection alert signal in response to the result of said evaluation. According to an embodiment of the present invention, evaluating the output signals can be a counter phase detecting within a predetermined time frame. The predetermined time frame can be an adjustable value between, for example, 1 to 30 seconds.

According to another embodiment, a fall is detected when a detection of an up to down movement of a person is not followed by a down to up movement or a horizontal movement detection in said predetermined time frame.

According to another embodiment, a first vertical PIR sensor 76 and a second vertical PIR sensor 77 are used. The output signals of the PIR sensors 76 and 77 are used together for evaluating and producing a fall detection alert signal in response to the result of said evaluation.

Additional information about the fall can be gained by determining the speed of a vertical downward motion. The following publication, (Wireless Sensor Networks for Activity Monitoring using Multi-sensor Multi-modal Node Architecture; Peter Hungt, Muhammad Tahir, Ronan Farrell, Sean McLoone and Tim McCarthy; Department of Electronic Engineering; Institute of Microelectronics and Wireless Systems; National University of Ireland Maynooth; Maynooth, Co. Kildare, Ireland) describes a multi-modal sensor node for human and vehicle activity monitoring. The publication proposes a method to achieve a more reliable direction and motion speed detection with two dual PIR sensors.

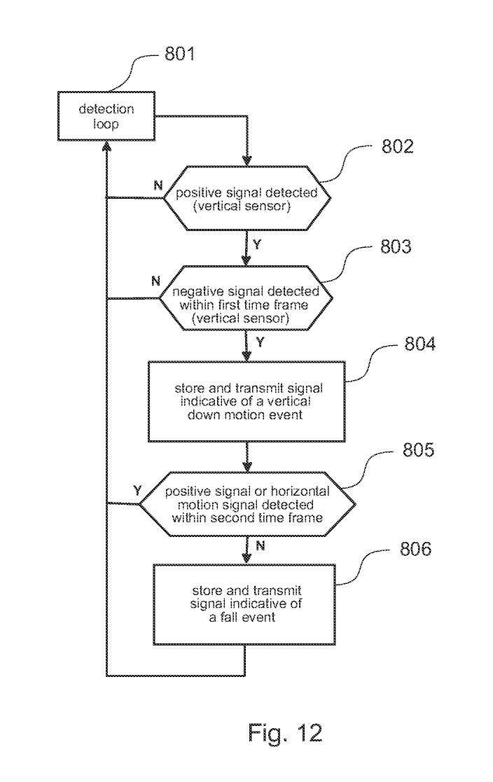

FIG. 12 illustrates an exemplary algorithm for the dual motion sensing PIR detection unit 10. The MCU receives the signals from the comparators respective to the direction and stores the direction data for further processing. In the case of a fall, the output of the vertical sensor will generate a negative signal 21 (see FIG. 6) before the positive signal 20 which indicates that the movement direction is up to down. At the beginning of the detection loop 801, in step 802 the MCU watches for a positive signal 20 detected from the output of a vertical PIR sensor 31. In the step 803, if the MCU detects a positive signal, the MCU determines whether the positive signal is followed by a negative signal within a predefined time frame. If a negative signal is detected within the predefined time frame, the MCU stores and transmits a signal indicative of a vertical down motion event in step 804. The MCU checks whether or not the signal indicative of a downwards motion direction (vertical down motion event) is followed by a signal generated by vertical movement from down to up, or a horizontal movement, within a predefined time frame in step 805. If not, the MCU generates an alert signal indicative of a fall event due to the fact that a fall of the person was detected with very high probability in step 806.

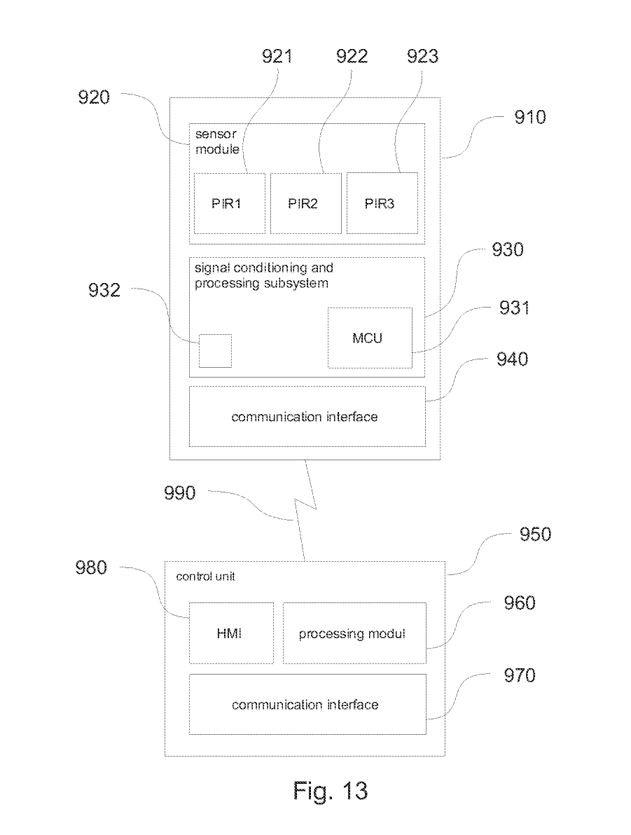

FIG. 13 shows a complex monitoring system according to an embodiment of the present invention. The MCU 931 is configured to generate an alert signal if an above mentioned threshold level is exceeded. The alert signal may be transmitted to a control unit 950, wherein the data can be further processed in the processing module 960, and/or the information about the fall might be sent through a communication interface 970 to caregiver personnel. Communication interface 970 communicates through a communications connection such as the telephone, GSM, Internet, or some other network.

The detection of a time period while the person is lying on the floor and the time of getting up can provide valuable information for the caregiver about the condition of the monitored person. With both the two and three sensor configurations 60 and 70, the MCU 931 may be configured to count the elapsed time between the fall and the first detection of upward motion, which indicates an attempt to stand up again. Moreover, the MCU 931 may be configured to count the elapsed time between the first detection of the upward motion and a horizontal motion, wherein the time range exceeds a certain threshold level, indicating that the person is already in a standing position and trying to walk. This information may be sent to the control unit 950 for further processing and/or to a device where this information is presented to the caregiver.

Furniture might play a role in the reliability of the detection; however, placing more sensors in the room can help to achieve a less error prone fall detection system. With regard to the furniture in the room, the following aspects can be taken into consideration. With two and three sensor configurations 60, 70, in the case the sensor has a view of the front side of a sofa or other seating, and the person can be detected in lying position, the MCU may be configured to differentiate between the fall and lying down by taking the following parameters 932 into consideration: the duration of a lower sensor signal detection is shorter downwards and will most probably contain an upwards motion component as well, when the person raises their leg on the sofa. It is probable to have a waiting period between a sitting and lying position, thus if a “sitting down” event is followed by a motion downwards, then there is a high probability that no fall event occurred. Between a sitting and lying position, a smaller amount of horizontal motion can be detected since only the head is visible by the horizontal sensor, whereas a full body fall has a higher probability to contain larger horizontal components.

Referring to FIG. 13, the PIR fall detection device 910 of the fall detection system is shown in a block diagram with a control unit 950. A various number of PIR fall detection devices 910 of the fall detection system are configured to be mounted in different locations of the patient's living area such as the living room, bedroom, bathroom, kitchen, and other locations in the home. The PIR fall detection devices 910 communicate with the control unit 950. The communication channel 990 may be wired or wireless. The console of the control unit 950 is typically located in the living area of the monitored person, where it is convenient for the patient to place and handle it. The control unit 950 may communicate with a central server that may provide administration for the system and transmit alerts to caregiver terminals. The PIR fall detection devices 910 of the fall detection system include: the communication interface 940; the sensor module 920 having at least two sensors 921, 922, 923; and the signal conditioning and processing subsystem 930 with at least one parameter 932.

In the alternative, there are many comparable arrangements to the above described arrangement such as wherein the control unit 950 communicates with a caregiver terminal, or directly with the caregivers, either through a communications connection such as the Internet, telephone, 3G, GSM or any wired or wireless networks.

Several embodiments of the user interface 980 are possible depending on the specific needs of the user installation. For home-based monitoring, an example user interface 980 takes the form of a PC with touch screen or other human machine interface that is located in the patient's house. The user interface might be in the same housing with the control unit, or might alternatively be in a separated housing connected by a wired or wireless communication network.

According to another embodiment, a user interface 980 comprises an announcement device and voice recognition capabilities to perform communication with the patient without the patient physically interacting with the console or caregiver involvement in the initial communication.

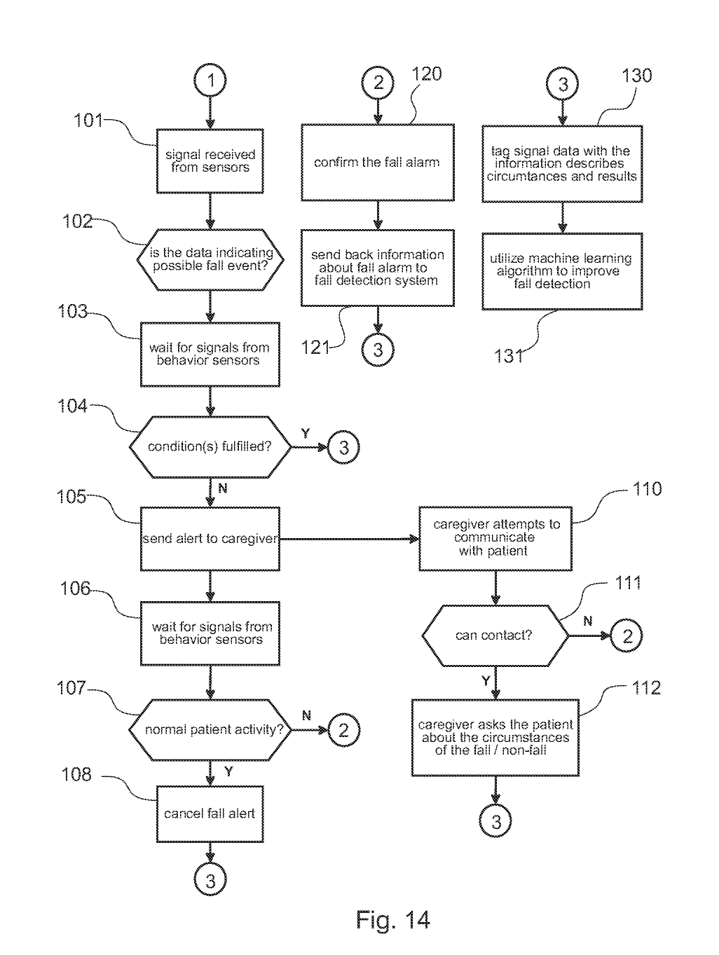

FIG. 14 illustrates a flow chart of fall detection according to an embodiment of the present invention. Once the PIR fall detection device 910 receives signals from the sensors in step 101, a detection of a possible fall event is determined at step 102. Then the system waits for signals from behavior sensors in step 103. All the related information, including parameters 932 of the processing algorithms, will be sent to the control unit 950, for storing and further analysis. The control unit 950 has a processing module 960, which is configured to make decisions based on the incoming data, and if it is determined that the data fulfills the predetermined conditions in step 104 to indicate a real fall event by sending an alert signal to the caregiver in step 105. For example, conditions may comprise allowing for fall alert cancelling, having multiple residents in the house, and so on.

The above mentioned behavior sensors perform continuous measurement of behavioral data of the individuals to be monitored. The behavioral data can be used, for example, to determine: the motion and/or location of the individual in a selected area; and, in the case of a body-worn sensor for sensing activity such as speed and/or acceleration of the motion of a selected body part of the individual, the motion activity of the individual.

Once a caregiver receives an alert, he or she will attempt to communicate with the patient in step 110 at the monitored site to verify that there is no medical or emergency issue. If the caregiver cannot contact to the patient in step 111, or the patient confirms the fall, an alarm is raised in step 120. At step 121, the alarm information is sent back to the fall detection system, which is configured to tag the data in step 130 related to the alarm for further processing. The caregiver may alternatively ask the patient about the circumstances of the fall/non-fall event in step 112.

The system may be configured to cancel a fall alert in step 108 once any kind of activity is detected from the patient at step 106, which activity indicates that the patient is performing normal daily activity as recognized in step 107.

One of the most common ways to utilize the PIR fall detection device 910 is to use it in a fall detection system, wherein the alerts generated by the sensor can be processed by the processing module 960 in the control unit 950 which collects and process the data arriving from many other PIR fall detection devices 910 utilized in the system. In a fall detection system where a sensor network is available, the system may be configured to cancel a fall alert 108 if, after the detected fall event motion, data is received from other sensor locations indicating a possible false positive detection. In the alternative, any other device capable of recording activity from the patient could provide this information. If the system is configured to cancel a fall alert 108, the patient need not live alone, otherwise, the system must be ready to handle pets and multiple residents in the patient's home.

Pet immunity may be achieved in the PIR fall detection device with proper algorithms that are designed for this purpose.

The presence of multiple persons in the monitored area can be detected either with this system or with other conventional motion detection systems. The system may be configured to warn the other person within the home to help in the case a fall event is detected.

Furthermore, the fall detection system may comprise pressure sensors placed on chairs and sofas to provide further information about the position of the person, thus making possible to ignore false fall events in the case of sitting or lying down on furniture where the pressure sensor is present. On the other hand, inserting additional sensors in the system makes the system more expensive.

In a fall detection system, the PIR fall detection device 910 might be extended with reinforcement learning capability, thus allowing the system to learn abnormal behavior of the patient. It may be achieved as follows: when the PIR fall detection device 910 detects a fall, the information is sent to the control unit 950, wherein the control unit 950 comprises a user interface 980 (human machine interface) to communicate with the patient and to ask the patient to confirm the fall event. In the alternative, the user interface 980 might be placed in a different location from the control unit 950, but still connected by any appropriate communication method. After confirmation of the fall event, the system sends back the data representing the answer of the person to the PIR fall detection device 910, which stores the pattern of the detected event and labels it with fall or no fall information. The MCU may be configured to run a machine-learning algorithm in step 131 (clustering algorithm, like k-means algorithm) that utilizes the tagged information to update the model used by the fall detection algorithm.

According to another embodiment, the system is configured to gain information from the person about the possible fall event. According to an embodiment, the fall event can be confirmed with a user interface 980 (terminal) placed in the patient's house. In this case, if there is no answer within a predefined time period, the system infers that a fall event has occurred with high probability such that the person needs the help of care providers. If the person is able to get up, and goes to the user interface 980 (terminal), two choices are indicated: the fall can be confirmed or denied. If the patient denies the fall event, a machine learning algorithm will be trained with the negative example, in order to avoid subsequently generating an alert for the same case. Otherwise, the learning algorithm stores the features of this event as a positive example and this data can be utilized as training data as well.

According to another embodiment, the system may be configured to perform the fall event confirmation via voice message. In this case, the person is informed with a voice message that a possible fall has been detected, and the patient's answer is detected with voice recognition, wherein the patient can either confirm or deny the fall event. The patient's voice is detected with a microphone and processed with a speech recognition algorithm as part of the fall detection system.

There are several features that the algorithm of the PIR fall detection device 910 on the MCU 931 can take into consideration. For example, features can be the frequency components of signals from the sensors; the phase of the signals, which indicate direction; the timing of the signals, where the order of the signals are taken into account; the time difference between the signals from the different sensors; the elapsed time after the last signal has been received; and, if an analog digital converter is utilized instead of the comparators, the amplitude of the signal.

According to the above embodiments of the present invention, a very cheap device can be provided and a largely accepted system can be built in any in-house environment which is able to reliably detect a fall of an elderly person in the field of view of the detector.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A device for detecting a fall, the device comprising:
a horizontal dual element PIR sensor having a vertical axis of symmetry;
at least one vertical dual element PIR sensor having a horizontal axis of symmetry;
a Fresnel lens array arranged in front of the horizontal dual element PIR sensor and optically focused in a direction parallel with the axis of symmetry of the horizontal dual element PIR sensor, wherein the Fresnel lens array divides a plane orthogonal to the axis of symmetry of the horizontal dual element PIR sensor into a plurality of horizontal zones, each zone comprising two sectors;
a Fresnel lens array arranged in front of the at least one vertical PIR sensor and optically focused in a direction parallel with the axis of symmetry of the at least one vertical dual element PIR sensor, wherein the Fresnel lens array divides a plane orthogonal to the axis of symmetry of the at least one vertical dual element PIR sensor into at least one vertical zone; and
a signal processing MCU configured to receive output signals from the horizontal dual element PIR sensor and the at least one vertical dual element PIR sensor, to evaluate a phase of the output signals, and to produce a fall detection alert signal in response to a result of the evaluation.

2. The device of claim 1, wherein the plurality of horizontal zones are narrower than about 10°.

3. The device of claim 1, wherein the output signals are forwarded to the signal processing MCU through an amplifier and through subsequent positive and negative signal comparators.

4. The device of claim 1, wherein the output signals are forwarded to the signal processing MCU through band pass filters.

5. The device of claim 1, wherein the at least one vertical dual element PIR sensor is arranged a vertical distance of between about 0.4 m and 0.9 m from the floor.

6. The device of claim 1, comprising a first vertical dual element PIR sensor and a second vertical dual element PIR sensor, wherein the second vertical dual element PIR sensor is arranged at a vertical distance from the first vertical dual element PIR sensor.

7. The device of claim 6, wherein the first vertical dual element PIR sensor and the second vertical dual element PIR sensor are arranged within a PIR detection unit.

8. A method for providing a fall detection signal, the method comprising:
arranging an infrared Fresnel lens array in front of a horizontal dual element PIR sensor and at least one vertical dual element PIR sensor, the Fresnel lens array having an optical focusing effect in a direction parallel with an axis of symmetry of at least one of the horizontal dual element PIR sensor and the at least one vertical dual element PIR sensor;
forwarding output signals of both the horizontal dual element PIR sensor and the at least one vertical dual element PIR sensor to a signal processing MCU;
evaluating a phase of the output signals of both the horizontal dual element PIR sensor and the at least one vertical dual element PIR sensor; and
producing a fall detection alert signal in response to the result of evaluating the phase of the output signals.

9. The method of claim 8, wherein forwarding the output signals of the PIR sensors to the signal processing MCU comprises forwarding the output signals through amplifiers and subsequent corresponding positive and negative signal comparators, and wherein evaluating the phase of the output signals comprises counter phase detecting within a predetermined time frame.

10. The method of claim 9, wherein the predetermined time frame is an adjustable value between about 1 second and about 30 seconds.

11. The method of claim 8, comprising producing a fall detection alert signal when the result of evaluating the phase of the output signals indicates detection of an up to down movement that is not followed by detection of either a down to up movement, or detection of a horizontal movement in the predetermined time frame.

12. The method of claim 8, wherein the at least one vertical PIR sensor comprises a first and a second vertical PIR sensor, and wherein the second vertical PIR sensor is arranged at a vertical distance from the first vertical PIR sensor.

13. A system comprising at least one device for providing fall detection, the device comprising:
a horizontal dual element PIR sensor having a vertical axis of symmetry;
at least one vertical dual element PIR sensor having a horizontal axis of symmetry;
a Fresnel lens array arranged in front of the horizontal dual element PIR sensor and optically focused in a direction parallel with the axis of symmetry of the horizontal dual element PIR sensor, wherein the Fresnel lens array divides a plane orthogonal to the axis of symmetry of the horizontal dual element PIR sensor into a plurality of horizontal zones, each zone comprising two sectors;
a Fresnel lens array arranged in front of the at least one vertical PIR sensor and optically focused in a direction parallel with the axis of symmetry of the at least one vertical dual element PIR sensor, wherein the Fresnel lens array divides a plane orthogonal to the axis of symmetry of the at least one vertical dual element PIR sensor into at least one vertical zone; and
a signal processing MCU configured to receive output signals from the horizontal dual element PIR sensor and the at least one vertical dual element PIR sensor, to evaluate a phase of the output signals, and to produce a fall detection alert signal in response to a result of the evaluation,
wherein the system comprises a control unit comprising a user interface connected to the at least one device through a communication interface, and wherein the control unit is configured to establish real-time communication between a caregiver and a person being supervised.
